(19) United States
(12) Patent Application Publication
(10) Pub. No.: US 2025/0121707 A1
(43) Pub. Date: Apr. 17, 2025

(54) Charging Cord Connecting Device And Method of Use

(71) Applicants: Nicholas DeSilva, Holmdel, NJ (US); Andrew Erdman, Holmdel, NJ (US)

(72) Inventors: Nicholas DeSilva, Holmdel, NJ (US); Andrew Erdman, Holmdel, NJ (US)

(21) Appl. No.: 18/379,744

(22) Filed: Oct. 13, 2023

(51) Int. Cl. B60L 53/16; B60L 53/18; B60L 53/30; H01R 13/447; H01R 13/74; H02J 7/00

(52) U.S. Cl. CPC B60L 53/16; B60L 53/18; B60L 53/30; H01R 13/447; H01R 13/74; H02J 7/0045

(57) ABSTRACT

A charging cord connecting device allowing for vehicle battery charging through an exterior wall of a building includes a housing having first and second ends to which are attached an inlet plug and a socket outlet, respectively. The socket outlet is electrically engaged to the inlet plug. The housing is mountable to an exterior wall of a building so that the housing extends through the exterior wall and so that the first and second ends are positioned internally and externally to the building, respectively. The inlet plug is connectable to a female connector of a first charging cord, which is electrically engaged to an electrical circuit of the building. The socket outlet is connectable to a second charging cord to supply current to a battery charger of an electric vehicle (EV), which is positioned outside of the building, to charge a battery of the EV.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to electrical cord connectors and more particularly pertains to a new electrical cord connector allowing for vehicle battery charging through an exterior wall of a building. An owner of and Electric Vehicles (EV) often has a wall mounted charging station equipped with a first charging cord in their garage, along with a second charging cord that is stowed in the EV. In circumstances wherein the EV cannot be parked in the garage, the owner might extend a charging cord under a door of the garage for overnight charging, which entails risk of entry of varmints, insects, or the like, as well as a less secure barrier to unauthorized entry into the garage. A solution allowing the owner to utilize their existing charging cords to charge the EV when it is parked outside of the garage, without passing a charging cord through the garage door opening, is desirable.

### (2) Description of Related Art Including Information Disclosed Under 37 CFR 1.97 and 1.98

The prior art relates to electrical cord connectors but which do not allow for through wall installation to enable use of available charging cords to charge a battery of a vehicle that is outside of a building.

### (H) BRIEF SUMMARY OF THE INVENTION

An embodiment of the disclosure meets the needs presented above by generally comprising a housing having first and second ends. The housing is configured to be mountable to an exterior wall of a building so that the housing extends through the exterior wall and so that the first and second ends are positioned internally and externally to the building, respectively. An inlet plug and a socket outlet are attached to the first and second ends of the housing, respectively, with the socket outlet being electrically engaged to the inlet plug. The inlet plug is complementary to and configured for connection of a female connector of a first charging cord, which is electrically engaged to an electrical circuit of the building. The socket outlet is configured to be connected to a second charging cord to supply current to a battery charger of an electric vehicle (EV) to charge a battery of the EV.

Another embodiment of the disclosure includes a battery charging system, which comprises a charging cord connecting device, according to the disclosure above, a first charging cord, which is electrically engaged to an electrical circuit of a building, a second charging cord, and an EV. The electric vehicle comprises a battery, a battery charger, and a vehicle plug. The housing is mounted to an exterior wall of a building as described above. The first charging cord has an endpoint, distal from the electrical circuit, to which is attached a female connector. The female connector is connected to the inlet plug. The second charging cord has first and second termini to which are attached an extension plug and an extension outlet, respectively. The extension plug is connected to the socket outlet and the extension outlet is connected to the vehicle plug to charge the battery.

Yet another embodiment of the disclosure includes a method of charging a vehicle battery through an exterior wall of a building, which entails provision of the battery charging system, according to the disclosure above. Steps of the method include mounting the housing to the exterior wall, connecting the female connector of the first charging cord to the inlet plug, connecting the extension plug to the socket outlet, connecting the extension outlet to the vehicle plug, and actuating the charging station to charge the battery.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an installed view of a charging cord connecting device according to an embodiment of the disclosure.

FIG. 2 is a detail view of an embodiment of the disclosure.

FIG. 3 is an in-use view of an embodiment of the disclosure.

FIG. 4 is a cross-sectional view of an embodiment of the disclosure.

FIG. 5 is a flow diagram for a method utilizing an embodiment of the disclosure.

### (J) DETAILED DESCRIPTION OF THE INVENTION

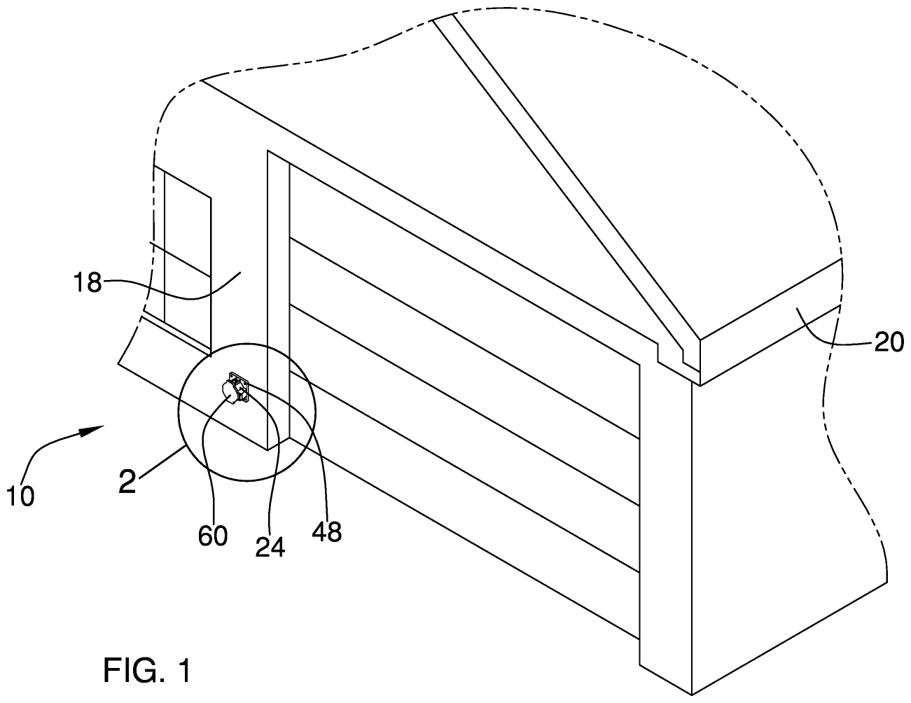

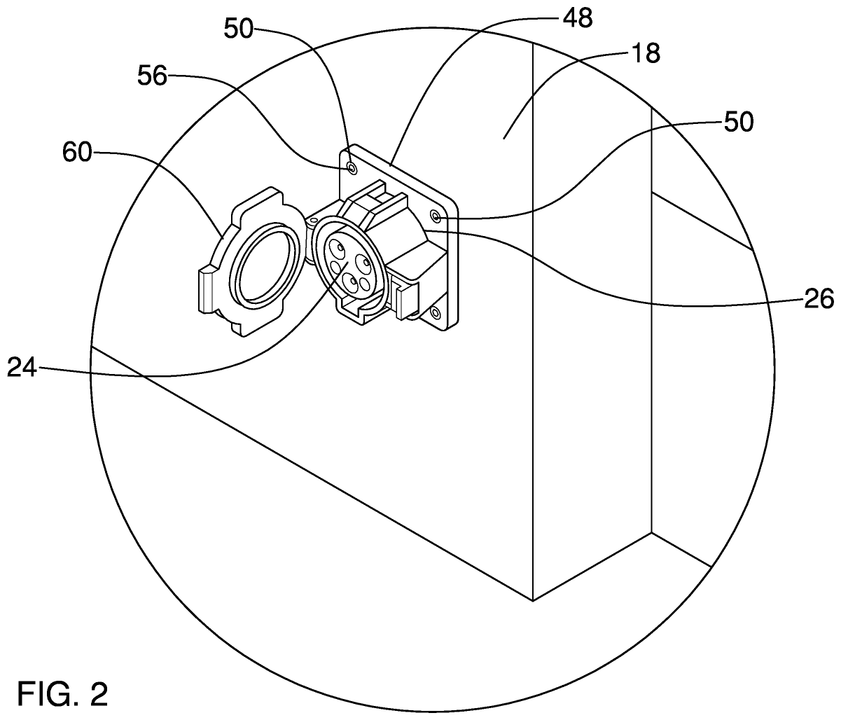

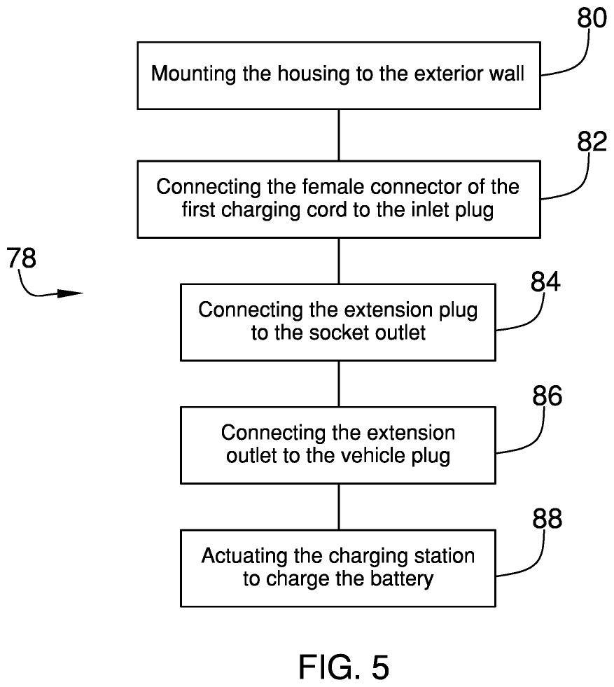

With reference now to the drawings, and in particular to FIGS. 1 through 5 thereof, a new electrical cord connector embodying the principles and concepts of an embodiment of the disclosure and generally designated by the reference numeral 10 will be described.

As best illustrated in FIGS. 1 through 5, the charging cord connecting device 10 generally comprises a housing 12 having a first end 14 and a second end 16. The housing 12 is configured to be mountable to an exterior wall 18 of a building 20 so that the housing 12 extends through the exterior wall 18 and so that the first end 14 and the second end 16 are positioned internally and externally to the building 20, respectively. Building, in the context of this disclosure, should be interpreted broadly to include an attached garage, a detached garage, a house, an office building, a warehouse, or the like.

An inlet plug 22 and a socket outlet 24 are attached to the first end 14 and the second end 16 of the housing 12, respectively, with the socket outlet 24 being electrically engaged to the inlet plug 22. The inlet plug 22 is complementary to and configured for connection of a female connector 26 of a first charging cord 28, which is electrically engaged to an electrical circuit 30 of the building 20. The socket outlet 24 is configured to be connected to a second charging cord 32 to supply current to a battery charger 34 of an electric vehicle (EV) 36 to charge a battery 38 of the EV 36.

The second charging cord 32 typically would be included with purchase of an EV 36 and used by an owner to charge the battery 38 at a charging location, such as is commonly found in a parking lots or a garage of an office building, a retail store parking lot, or the like. An owner often will purchase a charging station 40, also called a wall connector, which can be installed in their garage and which enables charging of the battery 38 using a first charging cord 28 that extends from the charging station 40. Thus, the charging cord connecting device 10 as depicted in the figures is configured to electrically couple the first charging cord 28 to the second charging cord 32 to allow the user to charge the battery 38 of their EV 36 while it is parked outside of the garage. While the first charging cord 28, in some instances, may be long enough to extend through a garage door opening to the EV 36, this precludes complete closing of the garage door with potentially undesirable outcomes. For example, rodents, bugs, and the like may gain access to the garage. Additionally, a partially open garage door presents an easier route to entry for a perpetrator to enter a garage than does a fully closed garage door.

Although the charging cord connecting device 10 as depicted in the figures is configured to be compliant with SAE J1772-2009, the present invention anticipates the inlet plug 22 and the socket outlet 24 being configured such that the charging cord connecting device 10 is compliant with any current or future standard, such as, but not limited to, SAE J3068, SAE J3400, IEC 62196, GB/T 20234, or the like. The present invention anticipates the inlet plug 22 being one of a plurality of inlet plugs 22 and the socket outlet 24 being one of a plurality of socket outlets 24, with the charging cord connecting device 10 being compliant with any current or future standards for Combo Couplers, such as, but not limited to, J1772/CCS Combo Coupler, or the like.

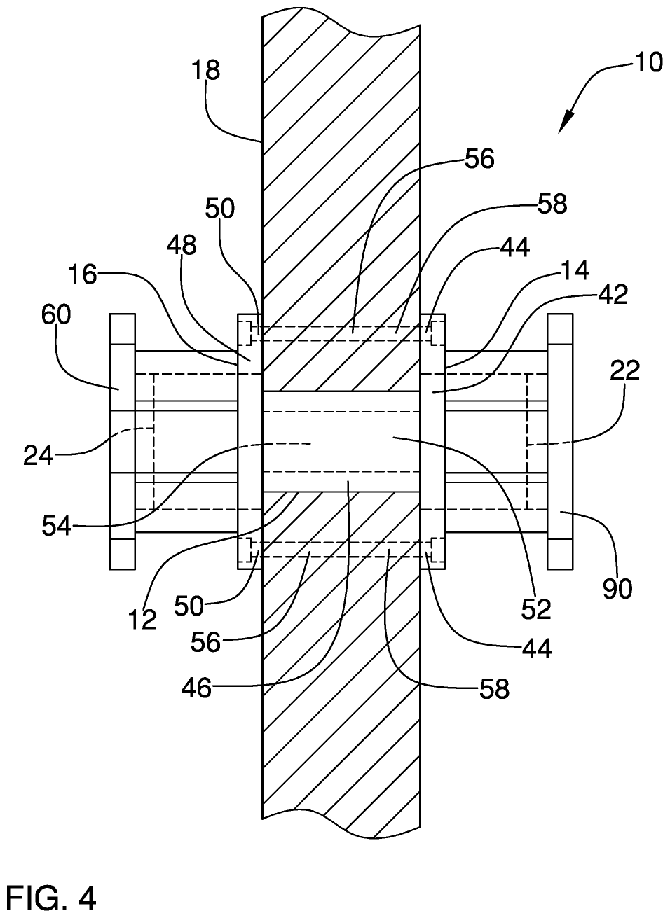

In one configuration, the housing 12 comprises a first flange 42, which has a plurality of first holes 44 positioned therein, a sleeve 46, and a second flange 48, which has a plurality of second holes 50 positioned therein. The inlet plug 22 is attached to the first flange 42. The second flange 48 is attached to and extends radially from the sleeve 46 and defines the second end 16 of the housing 12. The socket outlet 24 is attached to the second flange 48. The sleeve 46 is configured for insertion through a bore hole 52 in the exterior wall 18, as is shown in FIG. 4, so that the second flange 48 abuts the exterior wall 18 with the first end 14 of the housing 12 protruding from the exterior wall 18 into the building 20. The first flange 42 is positionable around the sleeve 46 so that the first flange 42 abuts the exterior wall 18.

A wiring harness 54 is attached to the socket outlet 24 and extends through the sleeve 46. The wiring harness 54 is connectable to the inlet plug 22 to electrically engage the inlet plug 22 to the socket outlet 24. Each article of attachment hardware 56 of a plurality of articles of attachment hardware 56 is insertable through a respective first hole 44, an aligned channel 58 in the exterior wall 18, and a respective second hole 50 to mount the housing 12 to the exterior wall 18, as is shown in FIG. 4.

In this embodiment, the charging cord connecting device 10 is configured for retrofitting an existing exterior wall 18 to allow for battery charging through the exterior wall 18. Other configurations of the charging cord connecting device 10 that allow for retrofitting an existing exterior wall 18 will be obvious to those skilled in the art of bulkhead fittings, such as, but not limited to, the first flange 42 being threadedly couplable to the sleeve 46 to form a compression fit to the exterior wall 18. The present invention also anticipates the charging cord connecting device 10 being configured for installation during construction of a building 20, such as a box that is attachable to a wall stud during construction.

The charging cord connecting device 10 may include one or both of a first cap 90 and a second cap 60. The first cap 90 is hingedly attached to the inlet plug 22 and is selectively attachable to the inlet plug 22 to cover the inlet plug 22. The second cap 60 is hingedly attached to the socket outlet 24 and is selectively attachable to the socket outlet 24 to cover the socket outlet 24.

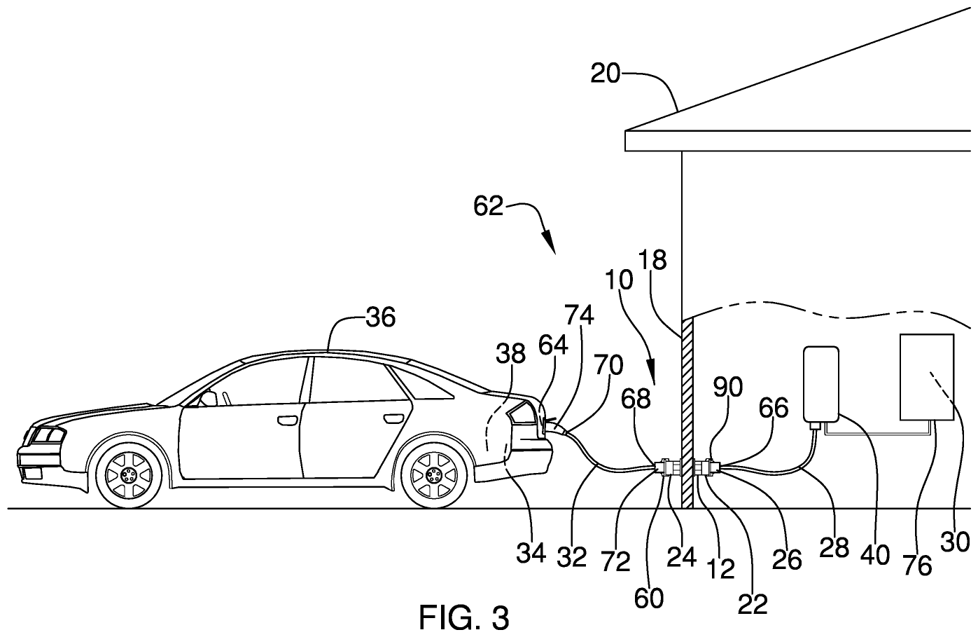

The present invention also includes a battery charging system 62, as is shown in FIG. 3 and which comprises a charging cord connecting device 10, according to the specification above, a first charging cord 28, which is electrically engaged to an electrical circuit 30 of a building 20, a second charging cord 32, and an EV 36. The EV 36 comprises a battery 38, which is rechargeable, a battery charger 34, which is electrically engaged to the battery 38, and a vehicle plug 64, which is electrically engaged to the battery charger 34.

The housing 12 of the charging cord connecting device 10 is mounted to an exterior wall 18 of a building 20 so that the housing 12 extends through the exterior wall 18 with the first end 14 and the second end 16 being positioned internally and externally to the building 20, respectively. The first charging cord 28 has an endpoint 66, distal from the electrical circuit 30, to which is attached a female connector 26. The female connector 26 is connected to the inlet plug 22. The second charging cord 32 has a first terminus 68 and a second terminus 70 to which are attached an extension plug 72 and an extension outlet 74, respectively. The extension plug 72 is connected to the socket outlet 24 and the extension outlet 74 is connected to the vehicle plug 64 to charge the battery 38.

The battery charging system 62 also may include a circuit panel 76, which is attached to the building 20, and a charging station 40. The charging station 40 is mounted within the building 20 and is electrically engaged to the circuit panel 76. The first charging cord 28 is operationally engaged to and extendable from the charging station 40.

In use, the battery charging system 62 enables a method of charging a vehicle battery through an exterior wall of a building 78, which entails provision of the battery charging system 62, according to the specification above. A first step 80 of the method 78 is mounting the housing 12 to the exterior wall 18 with the inlet plug 22 and the socket outlet 24 being positioned internally and externally to the building 20, respectively. A second step 82 of the method 78 is connecting the female connector 26 of the first charging cord 28 to the inlet plug 22. A third step 84 of the method 78 is connecting the extension plug 72 to the socket outlet 24. A fourth step 86 of the method 78 is connecting the extension outlet 74 to the vehicle plug 64. A fifth step 88 of the method 78 is actuating the charging station 40 to charge the battery 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A charging cord connecting device comprising:
a housing having a first end and a second end and being configured to be mountable to an exterior wall of a building such that the housing extends through the exterior wall and such that the first end and the second end are positioned internally and externally to the building, respectively;
an inlet plug being attached to the first end of the housing, the inlet plug being complementary to and configured for connection of a female connector of a first charging cord, wherein the first charging cord is electrically engaged to an electrical circuit of the building; and
a socket outlet being attached to the second end of the housing and electrically engaged to the inlet plug, wherein the socket outlet is configured for connecting to a second charging cord for supplying current to a battery charger of an electric vehicle for charging a battery of the electric vehicle.

2. The charging cord connecting device of claim 1, further including:
the housing comprising:
a first flange, the inlet plug being attached to the first flange, the first flange having a plurality of first holes positioned therein;
a sleeve;
a second flange attached to and extending radially from the sleeve and defining the second end of the housing, the socket outlet being attached to the second flange, wherein the sleeve is configured for insertion through a bore hole in the exterior wall such that the second flange abuts the exterior wall and such that the first end of the housing protrudes from the exterior wall into the building, the second flange having a plurality of second holes positioned therein, wherein the first flange is positionable around the sleeve such that the first flange abuts the exterior wall; and
a wiring harness attached to the socket outlet and extending through the sleeve, the wiring harness being connectable to the inlet plug for electrically engaging the inlet plug to the socket outlet; and
a plurality of articles of attachment hardware, each article of attachment hardware being insertable through a respective first hole, an aligned channel in the exterior wall, and a respective second hole for mounting the housing to the exterior wall.

3. The charging cord connecting device of claim 1, further including:
a first cap hingedly attached to the inlet plug and being selectively attachable to the inlet plug for covering the inlet plug; and
a second cap hingedly attached to the socket outlet and being selectively attachable to the socket outlet for covering the socket outlet.

4. A battery charging system comprising:
a housing having a first end and a second end, the housing being mounted to an exterior wall of a building such that the housing extends through the exterior wall and such that the first end and the second end are positioned internally and externally to the building, respectively;
an inlet plug being attached to the first end of the housing;
a socket outlet being attached to the second end of the housing and electrically engaged to the inlet plug;
a first charging cord being electrically engaged to an electrical circuit of the building, the first charging cord having an endpoint distal from the electrical circuit;
a female connector being attached to the endpoint of the first charging cord, the female connector being connected to the inlet plug;
a second charging cord having first terminus and a second terminus;
an extension plug being attached to the first terminus of the second charging cord and connected to the socket outlet;
an extension outlet being attached to the second terminus of the second charging cord; and
an electric vehicle comprising:
a battery, the battery being rechargeable;
a battery charger being electrically engaged to the battery; and
a vehicle plug being electrically engaged to the battery charger and connected to the extension outlet for charging the battery.

5. The battery charging system of claim 4, further including:
a circuit panel being attached to the building; and
a charging station being mounted within the building and electrically engaged to the circuit panel, the first charging cord being operationally engaged to and extendable from the charging station.

6. The battery charging system of claim 4, further including:
a first cap being hingedly attached to the inlet plug and being selectively attachable to the inlet plug for covering the inlet plug; and
a second cap hingedly attached to the socket outlet and being selectively attachable to the socket outlet for covering the socket outlet.

7. A method of charging a vehicle battery through an exterior wall of a building, the method comprising providing the battery charging system of claim 4, and:
mounting the housing to the exterior wall such that the housing extends through the exterior wall and such that the inlet plug and the socket outlet are positioned internally and externally to the building, respectively;
connecting the female connector of the first charging cord to the inlet plug;
connecting the extension plug to the socket outlet; and
connecting the extension outlet to the vehicle plug to charge the battery.

8. The method of claim 7, further including:
a circuit panel being attached to the building;
a charging station being mounted within the building and electrically engaged to the circuit panel, the first charging cord being operationally engaged to and extendable from the charging station; and
the method including an additional step of actuating the charging station to charge the battery.
